(19) United States
(12) Patent Application Publication
(10) Pub. No.: US 2015/0205336 A1
(43) Pub. Date: Jul. 23, 2015

(54) RESILIENT DATA AND POWER SUPPLIES

(71) Applicants: Allied Telesis Holdings Kabushiki Kaisha, Tokyo (JP); ALLIED TELESIS, INC., Bothell, WA (US)

(72) Inventor: Graham Walker, Christchurch (NZ)

(21) Appl. No.: 14/331,076

(22) Filed: Jul. 14, 2014

Related U.S. Application Data
(60) Provisional application No. 61/928,980, filed on Jan. 17, 2014.

(51) Int. Cl. G06F 1/26; G06F 11/30; G06F 1/30

(52) U.S. Cl. CPC G06F 1/263; G06F 1/30; G06F 11/3058

(57) ABSTRACT

A device includes a first power over Ethernet (POE) port and a second POE port. One of the first POE port and the second POE port is configured as a primary port to supply power and another one of the first POE port and the second POE is configured as a redundant port to supply power. The supply of power through the primary POE port is disabled and supply of power through the redundant POE port is enabled responsive to the supply of power through the primary POE port being non-conformant with a given standard.

### RELATED APPLICATIONS

This application claims the benefit of and priority to the U.S. provisional patent application No. 61/928,980, filed on Jan. 17, 2014, by the same inventor, Walker et al.

### BACKGROUND

Use of Ethernet connections has become prevalent and has enabled remote monitoring of devices while establishing reliability of data transmission at a reduced installation cost. Typically, mission critical devices may be connected via two or more Ethernet cables in the event that one cable or connection fails so the data connection can be reestablished using the additional Ethernet cable/connection. However, a loss of power to the device results in data transmission failure regardless of the number of Ethernet connections.

Some have used power over Ethernet (POE) to both power a device and enable data communication. Unfortunately, when a POE fails data communication may be lost unless an additional Ethernet cable/connection is used. However, as mentioned above, the additional Ethernet cable/connection is not a remedy when the power fails. Some have used a redundant power supply external to the device, resulting in a more unreliable, costly and complicated system.

### SUMMARY

Accordingly, a need has arisen to provide resilient power and data communication. According to some embodiments power and data transmission are maintained through a redundant system even in the presence of a power failure or data transmission failure of the primary system, and without use of a redundant external power supply. According to some embodiments, use of more than one power over Ethernet (POE) provides a device with a primary and a redundant POE in the event one fails, thereby maintaining power and data connection without use of a redundant external power supply.

According to one embodiment, a device includes a first power over Ethernet (POE) port and a second POE port. According to one embodiment, one of the first POE port and the second POE port is configured as a primary port to supply power and another one of the first POE port and the second POE is configured as a redundant port to supply power. In one embodiment, supply of power through the primary POE port is disabled and supply of power through the redundant POE port is enabled responsive to the supply of power through the primary POE port being non-conformant with a given standard.

Some embodiments include the above, wherein the first and the second POE ports are output ports on at least one source device configured to supply power to a sink device. According to one embodiment, the first POE port and the second POE port are input ports on a sink device.

According to one embodiment, the device further includes a monitoring circuit and a control circuit. The monitoring circuit may be configured to monitor supply of power through the primary POE port and further configured to determine whether supply of power through the primary POE port is conformant to the given standard. The control circuit may be configured to enable supply of power on the redundant POE port and disable supply of power on the primary POE port responsive to the monitoring circuit determining that the primary POE port is non-conformant to the given standard.

According to one embodiment, the monitoring circuit is further configured to monitor supply of power through the redundant POE port and determine whether supply of power through the redundant POE port is conformant to the given standard, and wherein the control circuit is further configured to enable supply of power on the primary POE port and disable supply of power on the redundant POE port responsive to the monitoring circuit determining that the redundant POE port is non-conformant to the given standard. According to one embodiment, the control circuit is configured to cause an alert signal to be triggered in response to determining that a POE port is non-conformant with the given standard.

It is appreciated that in some embodiment, the device may further include a switch configured to switch supply of power from the primary POE port to the redundant POE port responsive to a determination that the supply of power through the primary POE port is non-conformant with the given standard.

In one embodiment, data transmission capability associated with the redundant POE port remains enabled independent from whether supply of power through the redundant POE is enabled or disabled. It is appreciated that the non-conformant with the given standard comprises a power failure.

In some embodiment, a device includes a monitoring circuit and a control circuit. The monitoring circuit is configure to monitor supply of power through a first power over Ethernet (POE) line from a first source device and determine whether the supply of power through the first POE line is conformant with a given standard. The control circuit is configured to receive supply of power through the first POE line from the first source device and further configured to receive supply of power through a second POE line from a second source device. The control circuit is further configured to disable supply of power to a sink device through the first POE line and enable supply of power to the sink device through the second POE line in response to determining that the first POE line is non-conformant with the given standard.

According to some embodiments, the first source device and the second source device are POE ports on a same device. In some embodiments, the first source device is independent and separate from the second source device. In some embodiments, the monitoring circuit and the control circuit are components within the sink device. According to some embodiments data transmission capability associated with the first POE line and the second POE line remain enabled independent from whether supply of power through the first or the second POE lines is enabled or disabled.

According to some exemplary embodiments, the monitoring circuit is further configured to monitor supply of power through the second POE line from the second source device and determine whether the supply of power through the second POE line is conformant with the given standard.

In one exemplary embodiment, the control circuit is configured to disable supply of power to the sink device through the first POE line and enabling supply of power to the sink device through the second POE line is further in response to determining that the second POE line is conformant with the given standard.

It is appreciated that in one embodiment the non-conformant with the given standard comprises a power failure. It is appreciated that in some embodiments the control circuit is configured to cause an alert signal to be triggered in response to determining that a POE line is non-conformant with the given standard.

In some embodiments, a method includes monitoring power supply on a first power over Ethernet (POE) line. The method may further include determining whether power supply on the first POE line is conformant with a given standard. According to some embodiments, responsive to determining that power supply on the first POE line is non-conformant with the given standard, power supply on a second POE line is enabled, wherein the first and the second POE lines are configured to supply power from one or more source devices to a sink device.

In some exemplary embodiments, the method further includes monitoring power supply on the second POE line. Enabling power supply on the second POE line is responsive to power supply on the second POE line being conformant with the given standard, according to some embodiments.

It is appreciated that the non-conformant with the given standard according to some embodiments comprises a power failure. In some embodiments, the method may further include triggering an alert signal in response to determining that a POE line is non-conformant with the given standard.

### BRIEF DESCRIPTION OF DRAWINGS

The present invention is illustrated by way of example, and not by way of limitation, in the figures of the accompanying drawings and in which like reference numerals refer to similar elements.

FIG. 1A shows an exemplary system for providing resilient power and data using two source devices with power over Ethernet (POE) according to some embodiments.

FIG. 1B shows an exemplary system for providing resilient power and data using one source device with multiple POE ports according to some embodiments.

FIG. 2A shows an exemplary system for providing resilient power and data with two source devices and a monitoring component for monitoring the supply of power through one source device according to some embodiments.

FIG. 2B shows an exemplary system for providing resilient power and data with one source device with multiple POE ports and a monitoring component according to some embodiments.

FIG. 3 shows an exemplary system for providing resilient power and data with a monitoring component separate from a sink device configured for monitoring power supply from primary and redundant POE ports according to some embodiments.

FIG. 4 shows an exemplary system for providing resilient power and data with a monitoring component integrated with a sink device for monitoring the supply of power from primary and redundant POE ports according to some embodiments.

FIG. 5 shows an exemplary system for providing resilient power and data with two source devices, one source device with two POE ports according to some embodiments.

FIG. 6 shows an exemplary system for providing resilient power and data with two source devices, one source device with three POE ports according to some embodiments.

FIG. 7 shows a device according to some embodiments.

FIG. 8 shows yet another device according to some embodiments.

FIG. 9 shows one exemplary device according to some embodiments.

FIGS. 10A-D show exemplary flow diagram for selecting a primary source and for enabling a redundant for supplying power when the primary source is non-conformant to a given standard according to some embodiments.

FIGS. 11-13 show illustrative operations of systems according to some embodiments.

FIG. 14 shows an exemplary computer system in accordance with one embodiment.

FIG. 15 shows a block diagram of another exemplary computer system in accordance with one embodiment.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications, and equivalents, which may be included within the scope of the invention as construed according to the appended Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details. In other instances, well known methods, procedures, components, and circuits have not been described in detail as not to unnecessarily obscure aspects of the invention.

Some portions of the detailed descriptions that follow are presented in terms of procedures, logic blocks, processing, and other symbolic representations of operations on data bits within a computer memory. These descriptions and representations are the means used by those skilled in the data processing arts and data communication arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “identifying,” “creating,” “generating,” “storing,” “determining,” “sending,” “receiving,” “transmitting,” “communicating,” “providing,” “accessing,” “monitoring,” “triggering,” “associating,” “disabling,” “enabling,” “configuring,” “initiating,” “starting,” “terminating,” “ending,” “maintaining,” “overwriting,” “initializing,” “updating” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

A need has arisen to provide resilient power and data communication. According to some embodiments power and data transmission are maintained through a redundant system even in the presence of power failure or data transmission failure of the primary system, and without use of a redundant external power supply. According to some embodiments, use of more than one power over Ethernet (POE) provides a device with a primary and a redundant POE in case one fails, thereby maintaining power and data connection without use of a redundant external power supply.

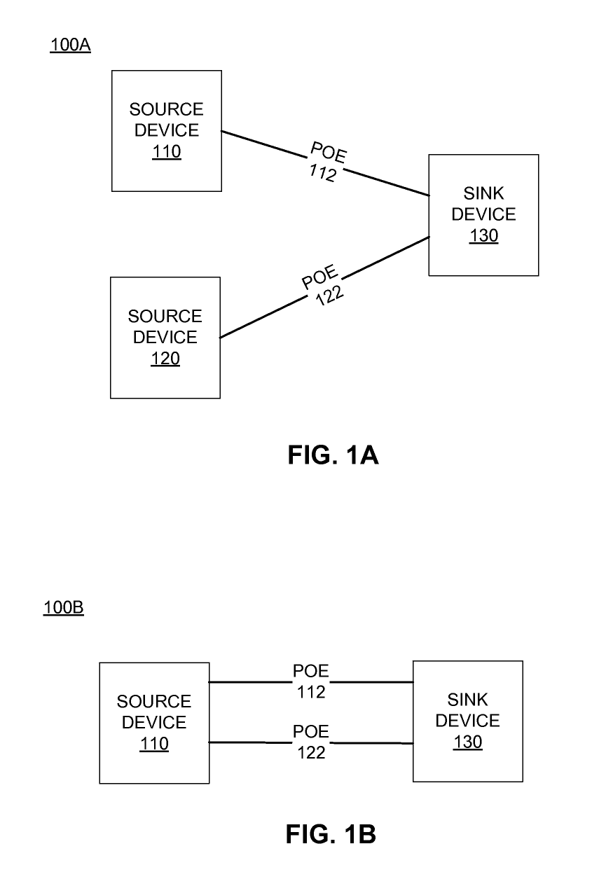

Referring now to FIG. 1A, an exemplary system 100A for providing resilient power and data using two source devices with power over Ethernet (POE) according to some embodiments is shown. In this exemplary system, a source device 110 is coupled to a sink device 130 via a POE 112. Similarly, a source device 120 is coupled to the sink device 130 via a POE 122. It is appreciated that the output connection of source devices 110 and 120 that couple the POE 112 and 122 to the sink device 130 may be an output POE port. According to some embodiments, the sink device 130 may be any electronic device, e.g., security cameras, data storage devices, IP phones, wireless access points, etc. Similarly, the source devices 110 and 120 may be any electronic devices such as a camera, POE switches, IP phones, data storage devices, a router, a switch, a server, a computer, etc.

According to some embodiments, the source device 110 provides power and data to the sink device 130 via a POE 112 cable connecting the output port of the source device 110 to the input port of the sink device 130. Similarly, the source device 120 provides power and data to the sink device 130 via a POE 122 cable connecting the output port of the source device 120 to the input port of the sink device 130. In other words, redundant power and data is provided to the sink device 130 in the event that a primary power and/or data fails or degrades.

For illustrative purposes, it is assumed that the source device 110 is selected as a primary power supplier to the sink device 130. It is appreciated that the source device 110 may be selected as the primary power supplier if the power supplied from the source device 110 via the POE 112 cable conforms to a given standard and quality. If the source device 110 is selected as a primary source, the source device 120 becomes a redundant power supplier in a situation where the source device 110 fails to provide power or in case the power provided by the source device 110 fails to conform to a given standard and quality, e.g., IEEE 802.3af, IEEE 802.3at, etc. In one embodiment, the failure to conform may include a situation where there is a power failure. Accordingly, redundant power and data is provided without using an external redundant power supply. It is appreciated that data may be transmitted while the power from the primary POE, e.g., POE 112, may not conform to the given standard because the power and data functionality of POE are independent of one another. As such, power may be provided from the source device 120 via POE 122 if the supply of power from the source device 110 does not conform to a given standard, while data may be provided through both of the source devices 110 and 120.

Similarly, in a different exemplary embodiment source device 120 is selected as a primary power supplier to the sink device 130. It is appreciated that the source device 120 may be selected as the primary power supplier if the power supplied from the source device 120 via the POE 122 cable conforms to a given standard and quality. If the source device 120 is selected as a primary source, the source device 110 becomes a redundant power supplier in a situation where the source device 120 fails to provide power or if the power provided by the source device 120 fails to conform to a given standard and quality, e.g., IEEE 802.3af, IEEE 802.3at, etc. Accordingly, redundant power and data is provided without using an external redundant power supply. It is appreciated that data may be transmitted while power from the primary POE, e.g., POE 122, may not conform to the given standard because the power and data functionality of POE are independent of one another. As such, power may be provided from the source device 110 via POE 112 if the supply power from the source device 120 does not conform to a given standard while data may be provided through both of the source devices 110 and 120.

It is appreciated that under certain circumstances, additional power may be desirable for the sink device. For example, to run optional functions on a sink device, additional power may be desired. As such, the primary power supplier and the secondary power supplier may be used simultaneously in order provide the necessary power to the sink device. As such, not only continuous power is supplied in event of a power failure or power non-conformity, but there is additional power available via the redundant power supply during power peak times.

Referring now to FIG. 1B, an exemplary system 100B for providing resilient power and data using one source device with multiple POE ports according to some embodiments. System 100B is substantially similar to that of 100A discussed above except that in system 100B instead of having two source devices, the same source device provides both a primary and a redundant power and data. For example, the source device 110 may have two output POE ports that couple the source device 110 to the input ports of a sink device 130 via POE cables 112 and 122 respectively. As such, one output port of the source device 110 acts as a primary POE and the other output port of the source device 110 acts as a redundant POE. Thus, if one POE connection or port fails, the other can provide power and data to the sink device 130. It is appreciated that similar to system 100A, system 100B is configured to not only continuous power is supplied in event of a power failure or power non-conformity, but there is additional power available via the redundant power supply during power peak times.

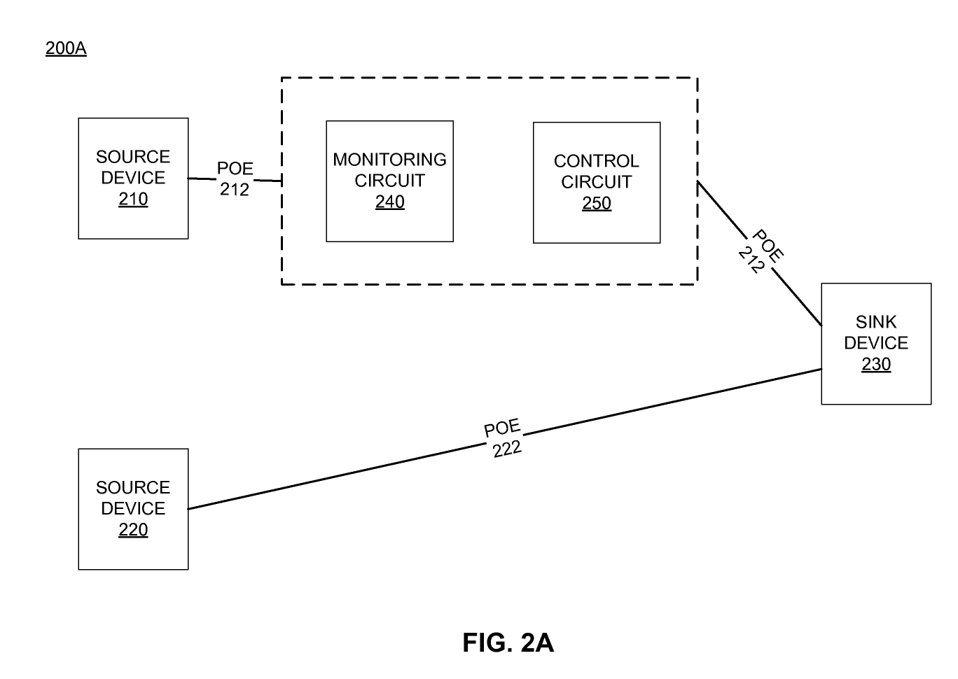

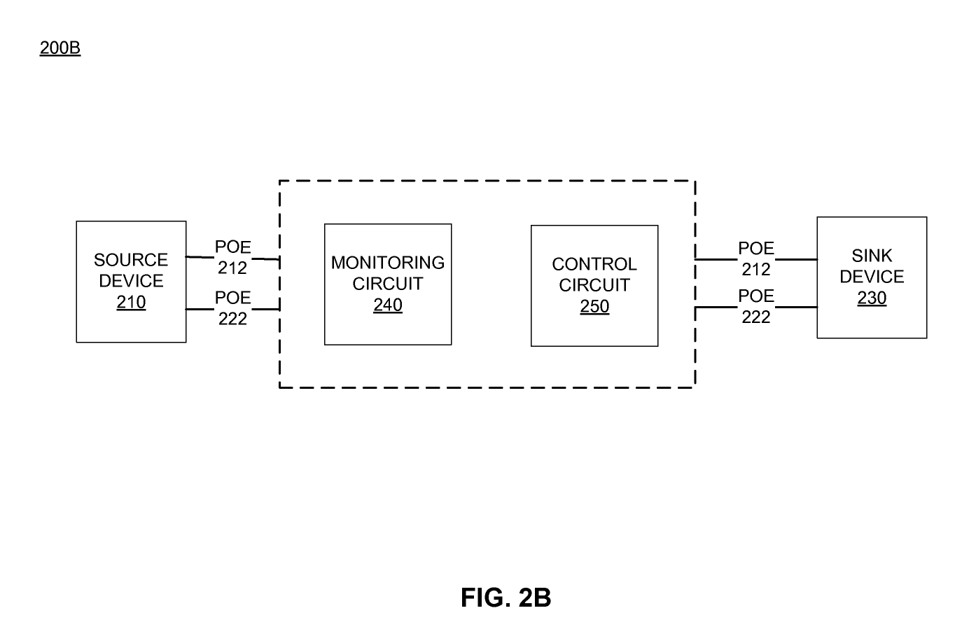

Referring now to FIG. 2A, an exemplary system 200A for providing resilient power and data with two source devices and a monitoring component for monitoring the power supply through one source device according to some embodiments is shown. System 200A includes a source device 210, a source device 220, a sink device 230, and POE cables 212 and 222 that operate substantially similar to the source device(s) 110 and 120, sink device 130, and POE cables 112 and 122 connecting the source device(s) to the sink device, as described above with respect to FIGS. 1A-1B. System 200A further includes a monitoring circuit 240 and a control circuit 250. The monitoring circuit 240 and/or control circuit 250 may include one or more microprocessors, field programmable gate arrays (FPGAs), discrete electronic components, or any combination thereof.

In this embodiment, the monitoring circuit 240 is configured to monitor the quality of the power supplied to the source device 210 via POE 212 cable. For example, the monitoring circuit 240 may monitor the supply power from the source device 210 to determine whether the supply power conforms to a given standard, e.g., IEEE 802.3af, IEEE 802.3at, etc. In one embodiment, the failure to conform may include a situation where there is a power failure. It is appreciated that according to one embodiment, the monitoring may be through monitoring a voltage, a current, or any combination thereof.

According to some embodiments, the control circuit 250 is configured to select the source device 210 as the primary power supply to the sink device 230 if the monitoring circuit 240 determines that the power supplied by the source device 210 via POE 212 conforms to a given standard. As such, the source device 220 is configured as a redundant source. The source device 220 maintains power to the sink device 230 in case of a supply power degradation or failure of the source device 210 via POE 212. In other words, the control circuit 250 causes the source device 220 to become enabled (if it is not enabled) and the supply power to the sink device 230 if the monitoring circuit 240 determines that the supply power from the source device 210 no longer conforms to the given standard. It is appreciated that the control circuit 250 may disable the primary source device 210 from supplying power if the supply of power by the primary source is non-conformant to the given standard. It is further appreciated that in some embodiments, more than one source device may remain enabled despite one of the source devices being non-conformant to the given standard. It is further appreciated that a corresponding monitoring circuit and the control circuit may also be used for the source device 220 (not shown). According to some embodiments, the monitoring circuit 240 and the control circuit 250 are integrated within the source device 210, are separate and independent standalone components, or are integrated within the sink device 230.

It is appreciated that under certain circumstances, additional power may be desirable for the sink device. For example, to run optional functions on a sink device, additional power may be desired. As such, the primary power supplier and the secondary power supplier may be used simultaneously in order provide the necessary power to the sink device. As such, not only continuous power is supplied in event of a power failure or power non-conformity, but there is additional power available via the redundant power supply during power peak times.

Referring now to FIG. 2B an exemplary system for providing resilient power and data with one source device with multiple POE ports and a monitoring component according to some embodiments is shown. System 200B is substantially similar to 200A as discussed above except that in system 200B, instead of having two source devices, the same source device provides a primary and a redundant power and data. For example, source device 210 may have two output POE ports that couple source device 210 to the input ports of the sink device 230 via POE cables 212 and 222 respectively. As such, one output port of the source device 210 acts as a primary POE and the other output port of the source device 210 acts as a redundant POE. Thus, if one POE connection or port fails, the other can provide power and data to the sink device 230. It is appreciated that similar to system 100A, system 100B is configured to not only continuous power is supplied in event of a power failure or power non-conformity, but there is additional power available via the redundant power supply during power peak times.

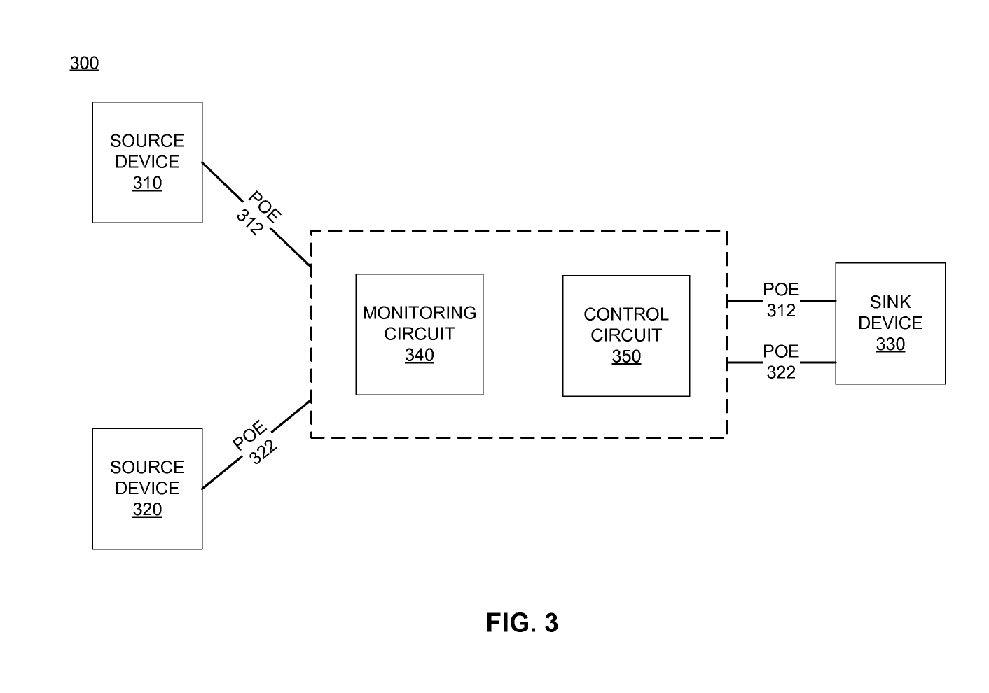

Referring now to FIG. 3 an exemplary system 300 for providing resilient power and data with a monitoring component separate from a sink device configured for monitoring the power supply from primary and redundant POE ports according to some embodiments is shown. System 300 includes source devices 310 and 320, a monitoring circuit 340, a control circuit 350, a sink device 330, and POE cables 312 and 322. The source device 310 and 320 and the sink device 330 are similar to those described above with respect to FIGS. 1A-1B, 2A and 2B and operate substantially similar to those described therein.

In this embodiment, the monitoring circuit 340 is substantially similar to monitoring circuit 240. However, in this embodiment the monitoring circuit 340 is configured to monitor the supply of power from both source devices 310 and 320. For example, the monitoring circuit 340 may monitor power supplied from the source devices 310 and 320 and determines which one, or both or none of those source devices conforms to a given standard. A source device, e.g., either source device 310 or 320, that conforms to the given standard may be selected by the control circuit 350 as the primary source, e.g., this example presumes that source device 320 is selected as a primary. A source device other than the primary source device, e.g., here source device 320, is selected by the control circuit 350 as a redundant source, e.g., in this example source device 310. Furthermore, the ports associated with the primary source and the redundant source may be selected as a primary port and a redundant port.

Accordingly, the source device 310 maintains power to the sink device 330 in case of supply power degradation or failure from the primary source, e.g., source device 320 via POE 322. In other words, the control circuit 350 causes the source device 310 to be enabled (if it is not enabled) and supply power to the sink device 330 if the monitoring circuit 340 determines that the supply power from the source device 320 no longer conforms to the given standard.

It is appreciated that the control circuit 350 may disable the primary source device 320 from supplying power if supply of power from the primary source does not conform to the given standard. It is further appreciated that in some embodiments, more than one source device may remain enabled despite one of the source devices being non-conformant to the given standard. It is further appreciated that more than one monitoring circuit and more than one control circuit may be used even though one monitoring circuit and one control circuit are shown for multiple source devices.

It is appreciated that under certain circumstances, additional power may be desirable for the sink device. For example, to run optional functions on a sink device, additional power may be desired. As such, the primary power supplier and the secondary power supplier may be used simultaneously in order provide the necessary power to the sink device. As such, not only continuous power is supplied in event of a power failure or power non-conformity, but there is additional power available via the redundant power supply during power peak times.

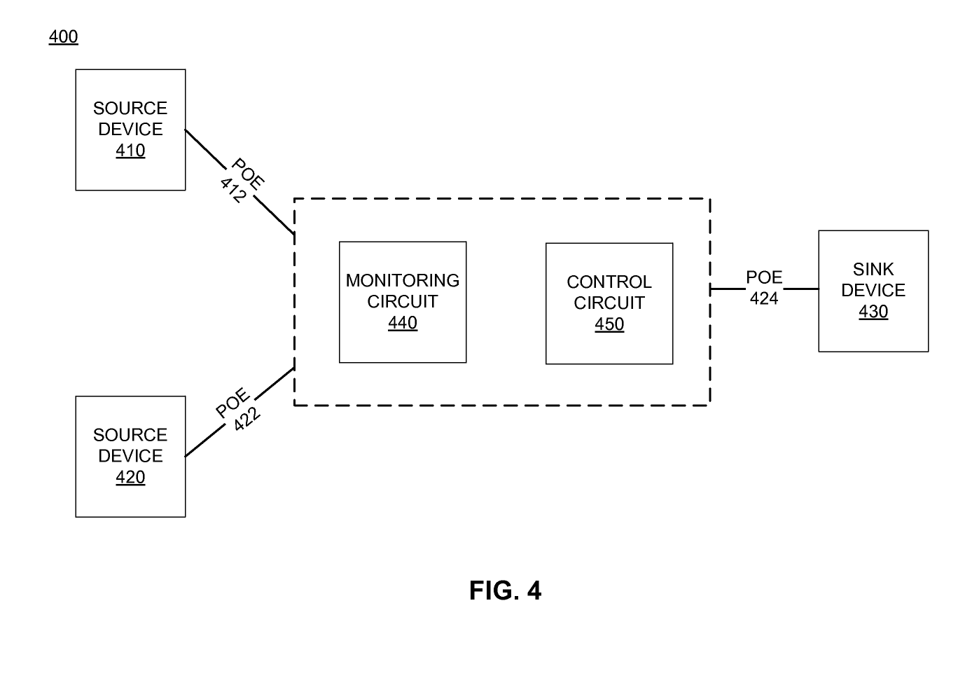

Referring now to FIG. 4, an exemplary system 400 for providing resilient power and data with a monitoring component integrated with a sink device for monitoring the power supply from primary and redundant POE ports according to some embodiments is shown. System 400 includes similar devices and components as system 300. System 400 operates substantially similar to system 300. In this embodiment, however, instead of two POE cables 312 and 314 coupling the control circuit 350 to the sink device 330, only one POE cable 424 is used to connect the control circuit 450 to the sink device 430. In system 400, the monitoring circuit 440 and the control circuit 450 may be integrated with the sink device 430. In system 400, the control circuit 450 selects the primary and the secondary sources and ports from the source devices 410 and 420 and routes the appropriate signal via POE 424 cable to the sink device 430.

It is appreciated that under certain circumstances, additional power may be desirable for the sink device. For example, to run optional functions on a sink device, additional power may be desired. As such, the primary power supplier and the secondary power supplier may be used simultaneously in order provide the necessary power to the sink device. As such, not only continuous power is supplied in event of a power failure or power non-conformity, but there is additional power available via the redundant power supply during power peak times.

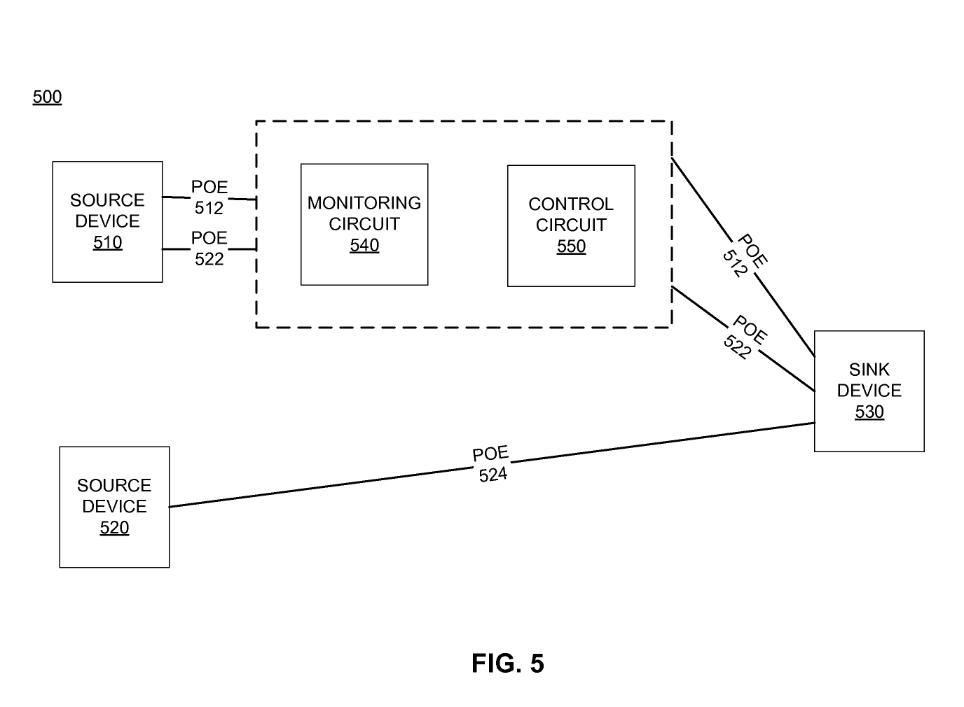

Referring now to FIG. 5, an exemplary system 500 for providing resilient power and data with two source devices, one source device with two POE ports according to some embodiments is shown. System 500 is a combination of systems 200A and 200B and operates substantially similar to the described systems 200A and 200B. System 500 shows an exemplary embodiment where one source device (e.g., source device 510) includes two output ports coupled to the monitoring circuit 540 via the POE 512 and 522 cables and a source device 520 is coupled to the sink device 530, via POE 524 cable, without any monitoring.

It is appreciated that under certain circumstances, additional power may be desirable for the sink device. For example, to run optional functions on a sink device, additional power may be desired. As such, the primary power supplier and the secondary power supplier may be used simultaneously in order provide the necessary power to the sink device. As such, not only continuous power is supplied in event of a power failure or power non-conformity, but there is additional power available via the redundant power supply during power peak times.

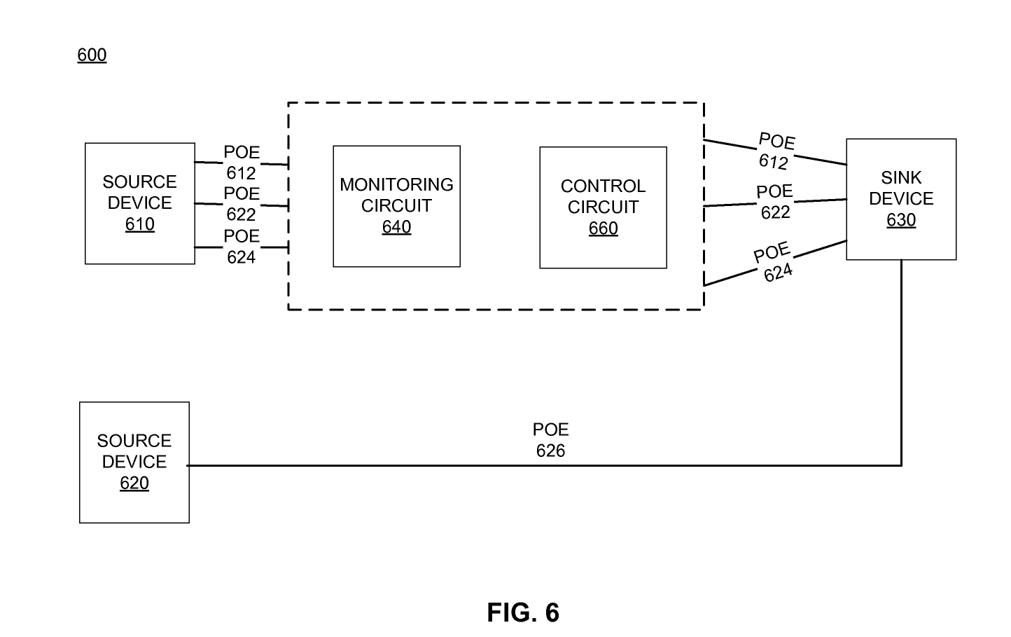

Referring now to FIG. 6, an exemplary system 600 for providing resilient power and data with two source devices, one source device with three POE ports according to some embodiments is shown. System 600 is similar to system 500 and operates substantially similar to system 500 described above. System 600 shows an exemplary embodiment where one source device (e.g., source device 610) includes three output ports coupled to the monitoring circuit 640 via the POE 612, 622, and 624 cables and a source device 620 is coupled to the sink device 630, via POE 626 cable, without any monitoring.

It is appreciated that under certain circumstances, additional power may be desirable for the sink device. For example, to run optional functions on a sink device, additional power may be desired. As such, the primary power supplier and the secondary power supplier may be used simultaneously in order provide the necessary power to the sink device. As such, not only continuous power is supplied in event of a power failure or power non-conformity, but there is additional power available via the redundant power supply during power peak times.

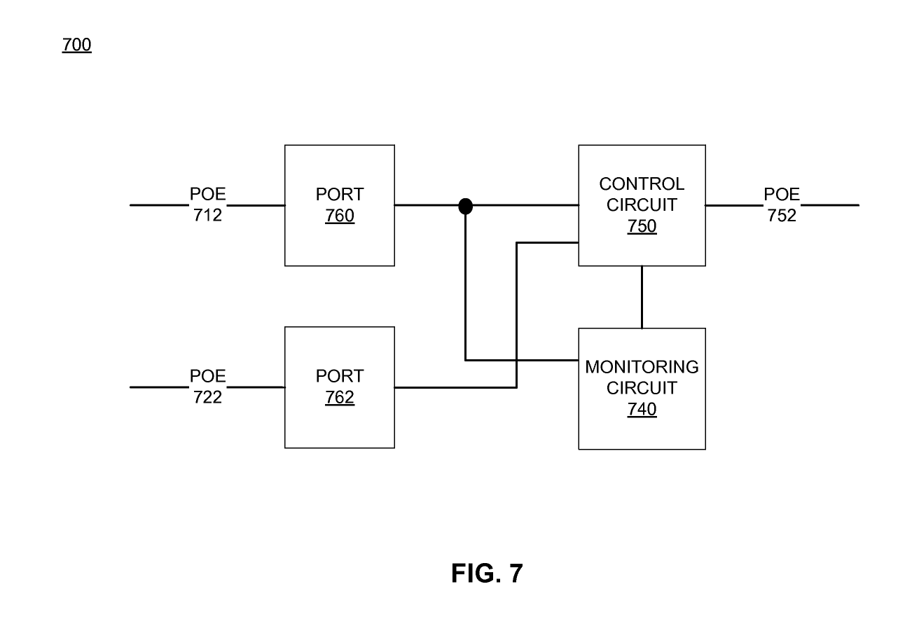

Referring now to FIG. 7, a device 700 according to some embodiments is shown. Device 700 includes two ports 760 and 762 (may be input ports), a control circuit 750, and a monitoring circuit 740. Port 760 receives power and/or data from a source, e.g., a source device as described above, via POE 712 cable. Port 762 receives power and/or data from a source, e.g., a source device as described above, via POE 722 cable. According to this embodiment, the monitoring circuit 740 monitors the supply power on port 760 to determine whether the supply power conforms to a given standard (as described above). In this embodiment, the supply power on port 762 via POE 722 cable is not monitored.

The monitoring circuit 740 is in communication with the control circuit 750 and provides the result of the determination of whether the supply power conforms to the given standard. The control circuit 750 may select the power supplied through port 760 via POE 712 cable as the primary source if the supply power from port 760 conforms to the given standard, thereby selecting the power supply through port 762 via POE 722 as a redundant source. In contrast, the control circuit 750 may select the power supplied through port 762 via POE 722 as the primary source if the supply power to port 760 is non-conformant to the given standard.

For illustrative purposes, it is assumed that the power supplied by a source device and its associated port (not shown) to port 760 is selected as a primary by being conformant to the given standard. The control circuit 750 may enable port 762 to provide power from a source device (not shown) if at a later point in time the monitoring device 740 determines that supply power on port 760 no longer conforms with the given standard. As such, redundant power and redundant data is provided. The power and data may then be provided to the sink device via POE 752 cable. It is appreciated that device 700 may be integrated within a sink device, a source device, or it may be a device coupling the source device(s) to the sink device. It is further appreciated that the supply power received at ports 760 and 762 may be from two different source devices or the same source device.

It is appreciated that under certain circumstances, additional power may be desirable for the sink device. For example, to run optional functions on a sink device, additional power may be desired. As such, the primary power supplier and the secondary power supplier may be used simultaneously in order provide the necessary power to the sink device. As such, not only continuous power is supplied in event of a power failure or power non-conformity, but there is additional power available via the redundant power supply during power peak times.

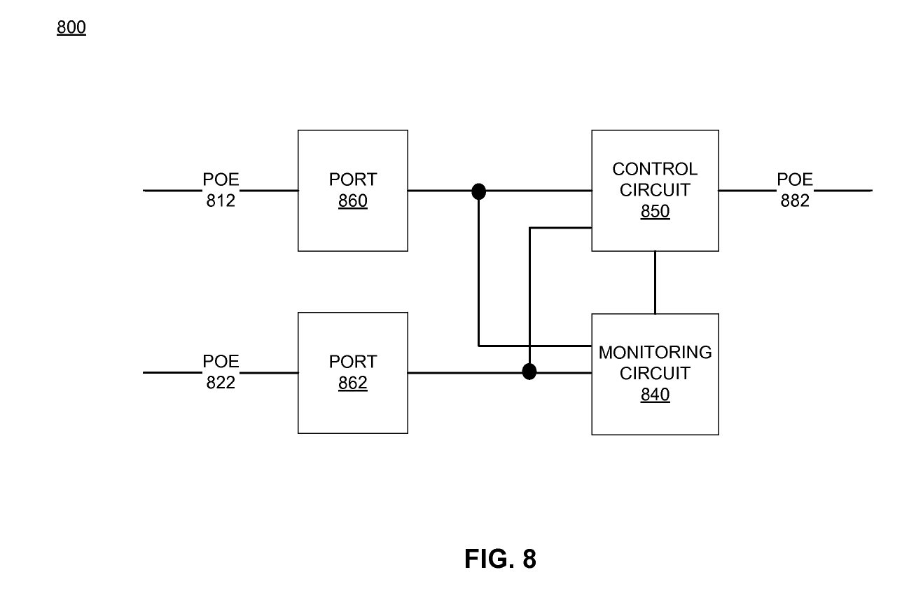

Referring now to FIG. 8, yet another device 800 according to some embodiments is shown. Device 800 is similar to that of 700 in FIG. 7 except that the monitoring circuit 840 monitors the supply power at both ports 860 and 862 received via POE 812 and 822 respectively.

It is appreciated that under certain circumstances, additional power may be desirable for the sink device. For example, to run optional functions on a sink device, additional power may be desired. As such, the primary power supplier and the secondary power supplier may be used simultaneously in order provide the necessary power to the sink device. As such, not only continuous power is supplied in event of a power failure or power non-conformity, but there is additional power available via the redundant power supply during power peak times.

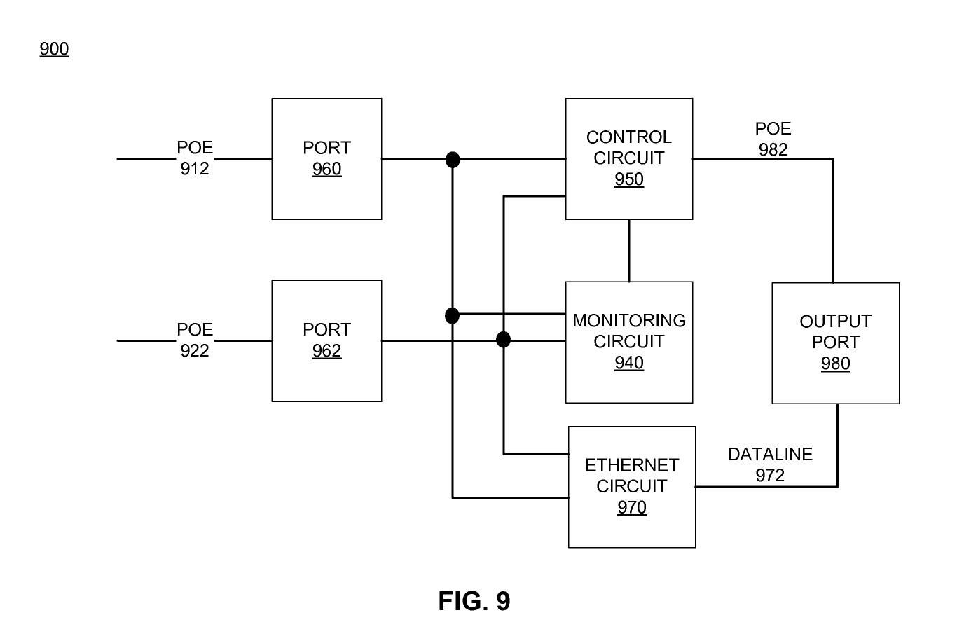

Referring now to FIG. 9, one exemplary device 900 according to some embodiments is shown. Device 900 is similar to that of FIG. 8 except that device 900 includes an Ethernet circuit 970 and an output port 980. Ethernet circuit 970 may be coupled to ports 960 and 962 for receiving data. The Ethernet circuit 970 may determine whether data received from port 960, port 962 or both should be relayed to the output port 980. The output port 980 also receives the supply power via POE 982 cable based on the operation of the monitoring circuit 940 and the control circuit 950.

It is appreciated that under certain circumstances, additional power may be desirable for the sink device. For example, to run optional functions on a sink device, additional power may be desired. As such, the primary power supplier and the secondary power supplier may be used simultaneously in order provide the necessary power to the sink device. As such, not only continuous power is supplied in event of a power failure or power non-conformity, but there is additional power available via the redundant power supply during power peak times.

It is appreciated that the monitoring circuit and/or the control circuit as described with respect to FIGS. 2B-9 may operate independently on different supply powers from one or more power source(s). In other words, different source devices or power sources from the same source device may be independently controlled by disabling/enabling the respective ports (input or output). Furthermore, it is appreciated that the supply of power and data signals may be independent and may therefore be independently controlled. As such, supply of power by one port may be independent of and have no impact on data transmission of that or other ports and vice versa. According to some embodiments, independent control of power may be via a switch mode power supply associated with each port for providing power, or it may be controlled by adjusting the output voltage and/or current of a switch mode power supply in order to adjust loading on each power supply, etc.

Moreover, it is appreciated that the monitoring circuit described above and/or the control circuit described above may trigger an alert signal in response to a determination of a source becoming non-conformant to the given standard. The alert signal may trigger a message to be send, e.g., email, MMS message, etc., or it may cause other forms of alerts, e.g., flashing lights, alarm may be sound, automated phone calls may be placed, etc.

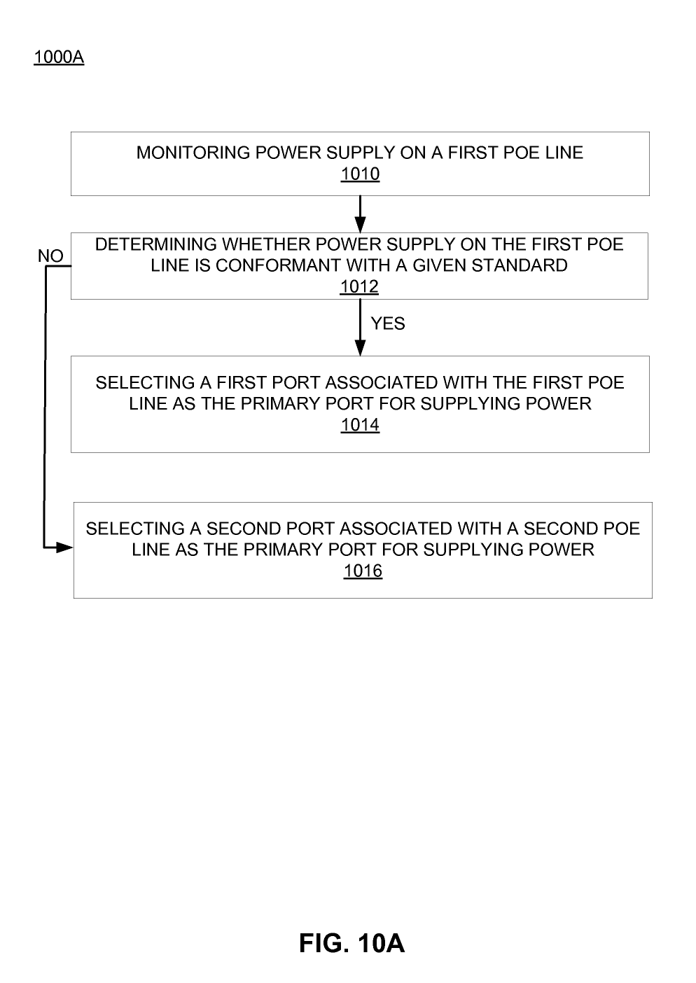

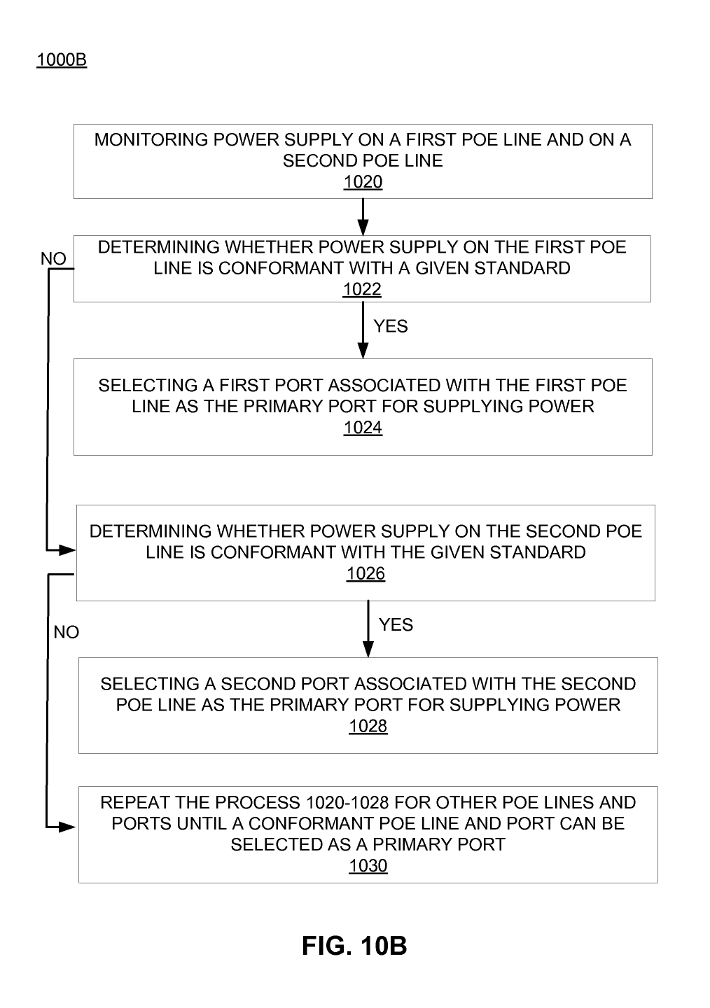

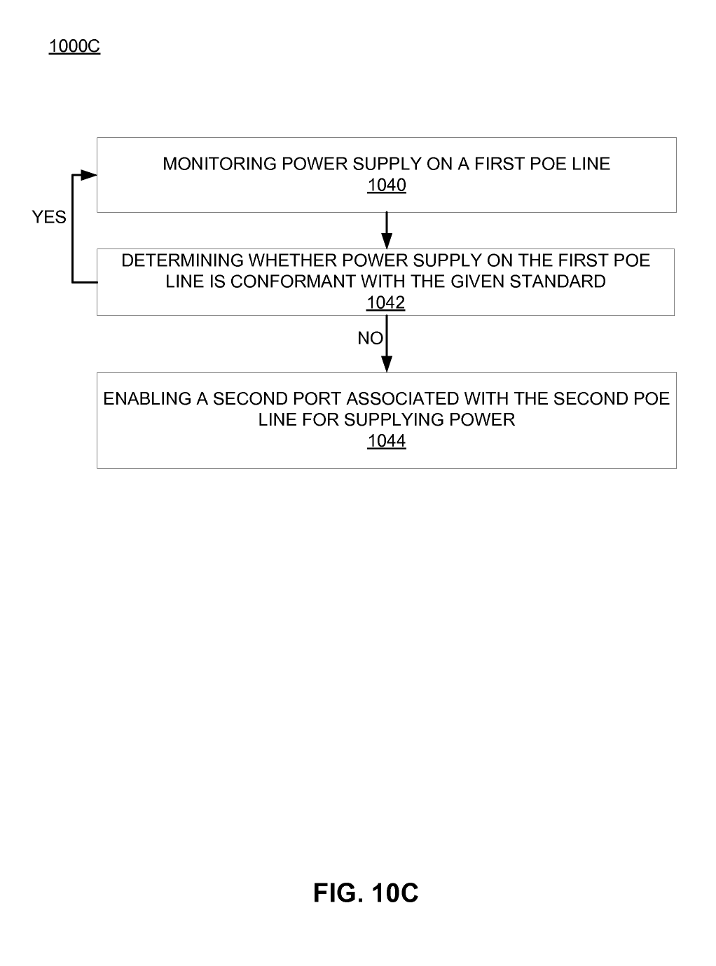

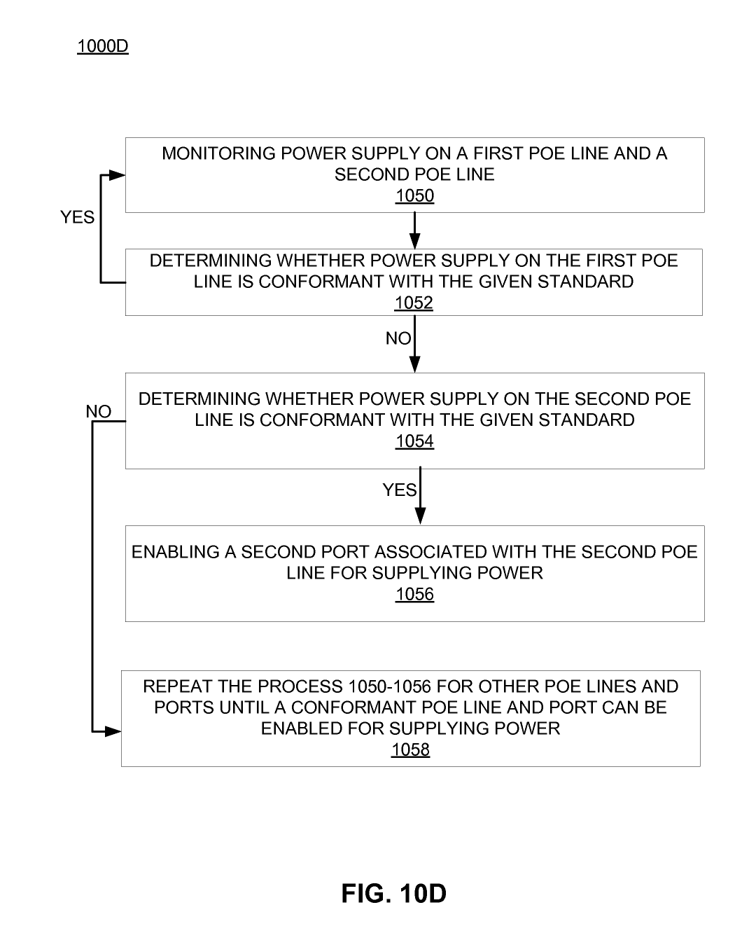

Referring now to FIGS. 10A-D exemplary flow diagrams for selecting a primary source and for enabling a redundant source for supplying power when the primary source is non-conformant to a given standard according to some embodiments are shown. At step 1010 of the flow 1000A, power supply on a first POE line is monitored, e.g., monitoring voltage, current, etc., as described above with respect to FIGS. 2A-9. At step 1012, it is determined whether the power supply on the first POE line is conformant with a given standard. For example, it may be determined whether the power supply conforms to an IEEE standard. It is appreciated that non-conformant may be a power failure. At step 1014, a first port associated with the first POE line is selected as the primary port for supplying power if the power supply on the first POE line conforms to the given standard. It is appreciated that the port may be an output port on a source device, an input port on a sink device, or a port on a device coupling the source device to a sink device. At step 1016, a second port associated with a second POE line is selected as a primary port for supplying power if the first POE line does not conform to the given standard.

Referring now to FIG. 10B, flow diagram 1000B for selecting a primary port is shown according to one embodiment. At step 1020, power supply on a first POE line and on a second POE line is monitored. At step 1022, it is determined whether the first POE line conforms to a given standard. If the first POE line conforms to the given standard, then at step 1024, the first port associated with the first POE line is selected as a primary port for supplying power to a sink device.

If the first POE line does not conform to the given standard, then at step 1026, it is determined whether the power supply on the second POE line conforms to the given standard. If the second POE line conforms to the given standard, then at step 1028, a second port associated with the second POE line is selected as the primary port for supplying power. At step 1030, if the second POE line does not conform to the given standard, then steps 1020-1028 are repeated for other POE lines until a conformant POE line is found and its associated port is selected as a primary port.

For illustrative purposes only, the following description of FIG. 10C presumes that the first POE line and its associated port is selected as a primary port. At step 1040, the power supply on the primary port and the first POE line is monitored. At step 1042, it is determined whether the power supply on the first POE line conforms to the given standard. If the power supply on the first POE line is conformant, then monitoring of power on the first POE line at step 1040 is repeated. On the other hand, if power supply on the first POE line does not conform to the given standard, then at step 1044, a second port associated with the second POE line is enabled in order to supply power to the sink device.

Referring now to FIG. 10D, steps 1050 and 1052 are substantially similar to steps 1040-1042 above. Instead of selecting the second POE port without investigating whether the first POE line fails to conform to the given standard (as was done in flow 1000C), at step 1054, it is determined whether the second POE line conforms to the given standard. If the second POE line is found to be conformant, then at step 1056 the second port associated with the second POE line is enabled for supplying power. Otherwise, at step 1058, process steps 1050-1056 are repeated for additional POE lines and port until a conformant POE line and its associated port are found and enabled.

It is appreciated that an alert signal may be triggered in response to finding a POE line non-conformant. The alert signal may trigger a message to be sent, e.g., email, MMS message, etc., or it may cause other forms of alerts, e.g., flashing lights, alarm may be sound, automated phone calls may be placed, etc.

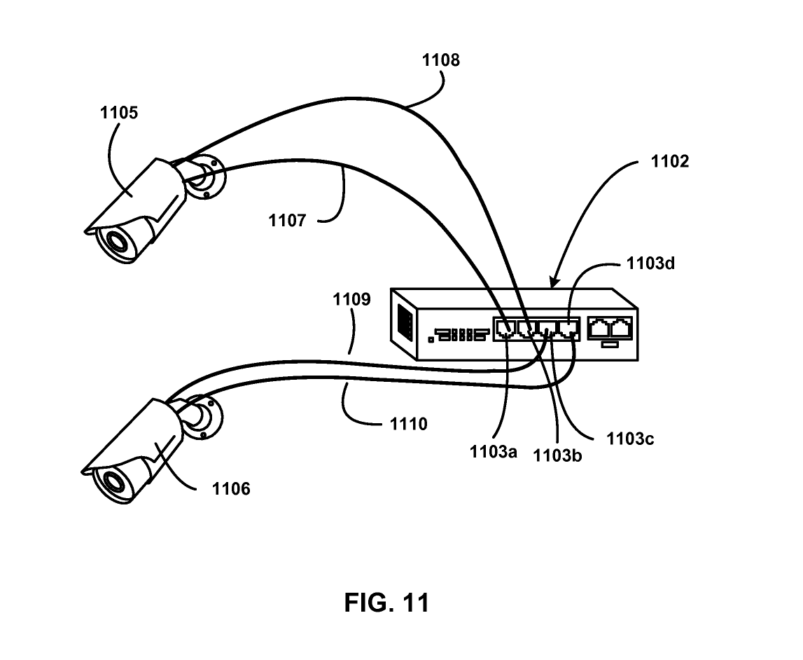

Referring now to FIGS. 11-13, illustrative operations of systems according to some embodiments are shown. Referring specifically to FIG. 11, a source device 1102, e.g., a network switch, and two sink devices 1105 and 1106, e.g., security cameras. The source device 1102 includes POE ports 1103a-d that couple the source device 1102 to the sink devices 1105 and 1106 via links 1107-1110, respectively, for providing power as well as data communication.

In this embodiment, the same source device 1102 is providing two connections to each of the sink devices 1105 and 1106. As such, one of the connections may be selected as the primary and the other as the redundant connection. For example, connection 1107 coupling output port 1103a of the source device 1102 may be selected as the primary port associated with the input port of the sink device 1105. It is appreciated that the primary port may be selected based on the process flows described above in FIGS. 10A-B or it may be selected based on no monitoring or determination whether the power supply conforms to a given standard. If the output port 1103a and its respective input port on the sink device 1105 are selected as the primary POE source, then the second output port 1103b and its respective input port on the sink device 1105 become the redundant POE source. As such, in the event that power supply on the POE line 1107 becomes non-conformant, POE line 1108 may be enabled and maintain power and data communication between the source device 1102 and the sink device 1105.

It is appreciated that in an exemplary embodiment, the output port 1103a may be the redundant POE source and the output port 1103b may be the primary POE source. It is appreciated that the interaction between the source device 1102 and the sink device 1106 is similar to that of sink device 1105 described above.

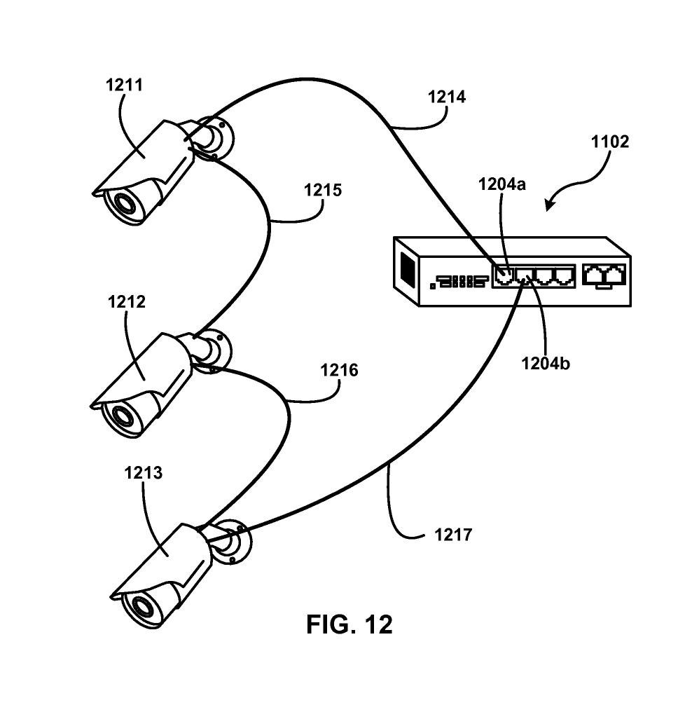

Referring now to FIG. 12, the source device 1102 is coupled to the sink devices 1211, 1212, and 1213. In this exemplary configuration, output port 1204a of the source device 1102 is coupled to the sink device 1211 via POE link 1214 and the output port 1204b of the source device 1102 is coupled to the sink device 1213 via the POE link 1217. The sink devices 1211-1213 are daisy chained together via POE links 1215 and 1216.

In this exemplary embodiment, output port 1204a may be selected as a primary POE source for the sink device 1211 and be provided via POE 1214 link. The primary POE source for the sink device 1212 is via the output port of the sink device 1211 and provided to the sink device 1212 via the POE 1215 link. The primary POE source for the sink device 1213 is via the output port of the sink device 1212 and provided to the sink device 1213 via the POE 1216 link. In contrast, output port 1204b may be selected as a redundant POE source for the sink device 1213 and provides redundant power via POE 1217 link. Similarly, the redundant POE source for the sink devices 1212 and 1211 are provided via the output ports from the sink devices 1213 and 1212 respectively via POE links 1216 and 1215 respectively.

It is appreciated that data may be transmitted via any of the ports independent of the selection of the primary and redundant POE source. In this exemplary embodiment, the monitoring and the control circuit may reside within the source device 1102. In another embodiment, the control and the monitoring circuit may reside outside of the source device 1102 and the sink devices 1211, 1212, and 1213. According to yet another embodiment, the monitoring and the control circuits may reside within the sink devices.

In this exemplary embodiment, if a primary POE source is found to be non-conformant, e.g., by monitoring the current, voltage, etc., with a given standard, e.g., IEEE, then the redundant POE source is enabled and maintains power to the sink devices. Non-conformance may be a power failure, damage to the POE links, etc. Non-conformance may trigger an alert signal, e.g., an email may be sent, alarm sound, lights flashing, SMS, MMS, etc.

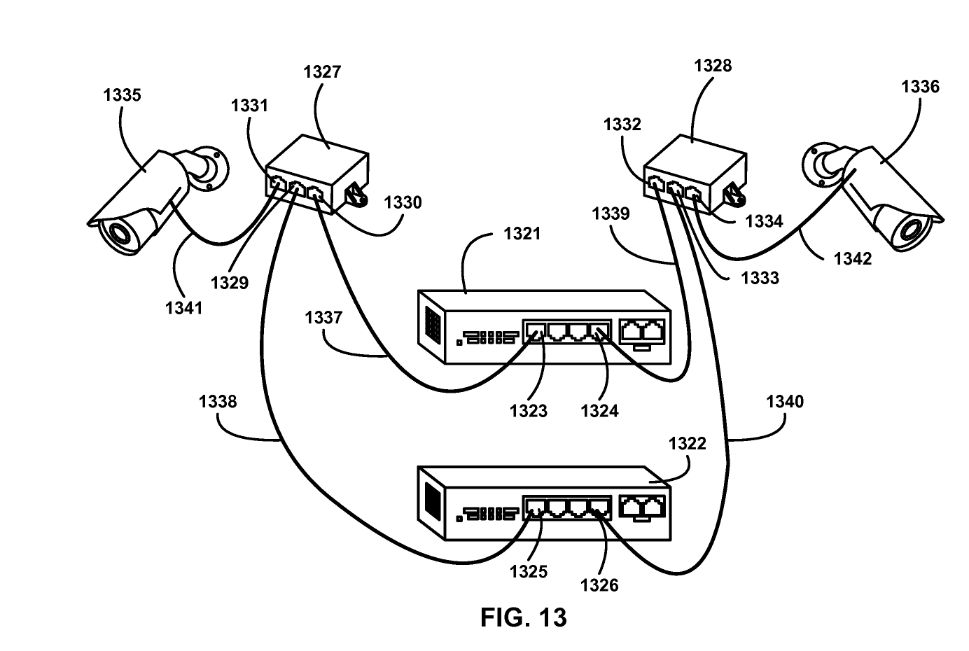

Referring now to FIG. 13, a first device 1321 and a second device 1322 for providing resilient POE are provided. It is appreciated that the first and the second device 1321 and 1322 may be referred to as source devices and, in this example, are networking switches. The first port 1323 of the first device 1321 is connected to first port 1330 of a first apparatus 1327 for receiving POE via Ethernet cable 1337. The second port 1324 of the first device 1321 is connected to the first port 1332 of a second apparatus 1328 for receiving POE via the Ethernet cable 1339.

The first port 1325 of the second device 1322 is connected to the second port 1329 of first apparatus 1327. The second port 1326 of second device 1322 is connected to a second port 1333 of the second apparatus 1328 via the Ethernet connection 1340. In this exemplary embodiment, the first and the second ports 1323-1324 of the first device 1321 are each configured to be enabled POE sources. In this example, the first and the second ports 1325-1326 of the second device 1322 are each configured to be enabled POE sources. The POE output port 1331 of the first apparatus 1327 is connected to a camera 1335 via the Ethernet cable 1341. The output port 1334 of the second apparatus 1328 is connected to the camera 1336 via the Ethernet cable 1342.

The first and the second apparatus 1327-1328 may each include monitoring circuits (not shown) configured to monitor the supply quality of each POE source, e.g., 1323, 1325 for apparatus 1327 and 1324, 1326 for apparatus 1328) and control circuits (not shown) for selecting which of the POE sources (1323, 1325 and 1324, 1326) are to be used to supply power.

For illustrative purposes only, the embodiment is described with respect to one specific configuration; however, at least four combinations of primary and redundant source are possible.

The first port 1330 of the first apparatus 1327 is configured as a primary POE input port and the second port 1329 is configured as a redundant POE input port. The first port 1332 of the second apparatus 1328 is configured as a redundant POE input port and the first port 1333 is configured as a primary POE input port. Accordingly, camera 1335 is powered from the first device 1321 POE port 1323 and camera 1336 is powered from the second device 1322 POE port 1326. It is appreciated that the first device 1321 and second device 1322 may be geographically spaced apart from each other. This provides a greater degree of redundancy because the power to each device 1321, 1322 may be supplied using a separate and an independent power supply network. In the event an Ethernet cable 1337-40 is cut, for example Ethernet cable 1337, the first apparatus 1327 monitoring circuit (not shown) detects the power being supplied to primary POE input port 1330 as not conforming with a pre-defined supply quality. The control circuit (not shown) in first apparatus 1327 therefore electrically connects the redundant POE input port 1329 to the output port 1331. Power supply to the camera 1335 is thus maintained using port 1325 of the second device 1322.

In the event that power is lost to either one of devices 1321 or 1322, the cameras are automatically supplied from the alternate device because either the first apparatus 1327 or the second apparatus 1328 detects that the power on a respective primary POE input port 1330 or 1333 does not conform to a pre-defined supply quality. The apparatus 1327 or 1328 that detects the primary POE power is not conforming to the pre-defined supply quality switches supply from the primary POE source 1330, 1333 to the secondary POE source 1329, 1332.

In embodiments that both the primary POE ports 1330, 1333 and the at least one redundant POE port 1329, 1332 are monitored, the apparatus 1327, 1328 may be configured to transmit signals over the Ethernet data connection 1337-1340. In the event that power is lost to a primary POE port 1330, 1333, power is reconfigured to be supplied from an at least one redundant POE port 1329, 1332. At the same time a message may be sent via an active data connection indicating that primary POE power has been lost and that reliance is on an at least one redundant POE source. According to one embodiment, if at least one redundant POE source is detected as supplying power that does not conform to a pre-defined supply quality, a message may be sent indicating that at least one redundant POE source is non-conformant. In some embodiments the message may be in the form of a link status indicator on the apparatus 1327, 1328. One non-limiting example of a link status indicator is an LED or the like.

It is appreciated that with reference to FIGS. 11-13, under certain circumstances, additional power may be desirable for the sink device. For example, to run optional functions on a sink device, additional power may be desired. As such, the primary power supplier and the secondary power supplier may be used simultaneously in order provide the necessary power to the sink device. As such, not only continuous power is supplied in event of a power failure or power non-conformity, but there is additional power available via the redundant power supply during power peak times.

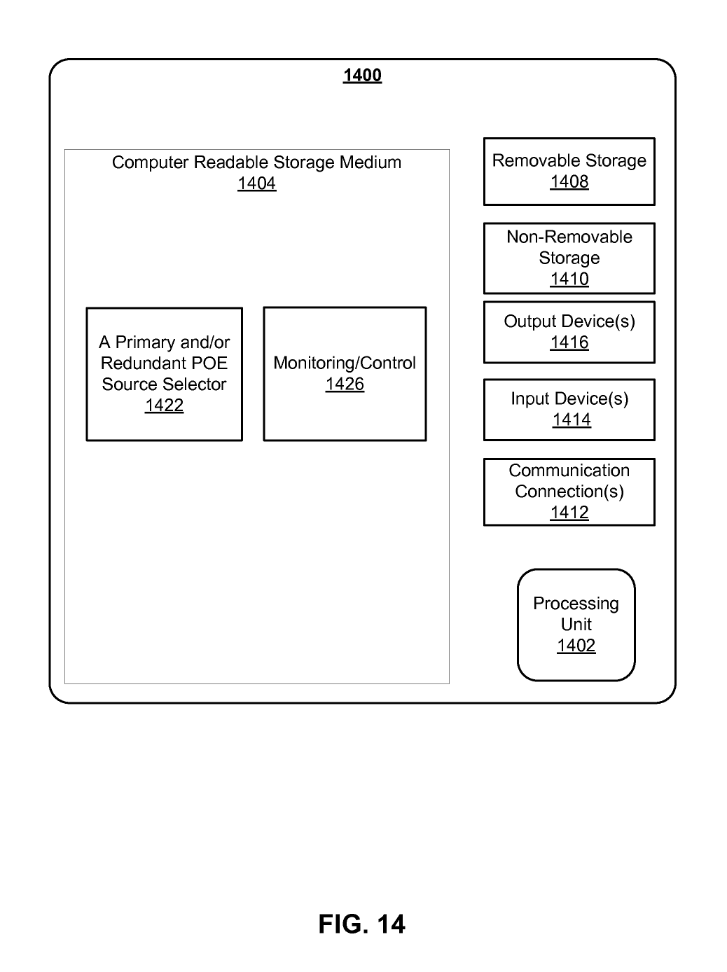

Referring now to FIG. 14, a block diagram of an exemplary computer system in accordance with one embodiment of the present invention is shown. With reference to FIG. 14, an exemplary system module for implementing embodiments includes a general purpose computing system environment, such as computing system environment 1400. Computing system environment 1400 may include, but is not limited to, servers, switches, routers, desktop computers, laptops, tablets, mobile devices, and smartphones. In its most basic configuration, computing system environment 1400 typically includes at least one processing unit 1402 and computer readable storage medium 1404. Depending on the exact configuration and type of computing system environment, computer readable storage medium 1404 may be volatile (such as RAM), non-volatile (such as ROM, flash memory, etc.) or some combination of the two. Portions of computer readable storage medium 1404 when executed facilitate selecting a primary POE source and a redundant POE source, monitoring whether the primary POE source conforms to a given standard, and switching to the redundant POE source if the primary POE source is found to be non-conforming accordance with embodiments herein (e.g., process 1000A-D).

Additionally, in various embodiments, computing system environment 1400 may also have other features/functionality. For example, computing system environment 1400 may also include additional storage (removable and/or non-removable) including, but not limited to, magnetic or optical disks or tape. Such additional storage is illustrated by removable storage 1408 and non-removable storage 1410. Computer storage media includes volatile and nonvolatile, removable and non-removable media implemented in any method or technology for storage of information such as computer readable instructions, data structures, program modules or other data. Computer readable medium 1404, removable storage 1408 and nonremovable storage 1410 are all examples of computer storage media. Computer storage media includes, but is not limited to, RAM, ROM, EEPROM, flash memory or other memory technology, expandable memory (e.g., USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 1400. Any such computer storage media may be part of computing system environment 1400.

In some embodiments, computing system environment 1400 may also contain communications connection(s) 1412 that allow it to communicate with other devices. Communications connection(s) 1412 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 1412 may allow computing system environment 1400 to communicate over various networks types including, but not limited to, fibre channel, small computer system interface (SCSI), Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 1412 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 1400 may also have input device(s) 1414 such as keyboard, mouse, a terminal or terminal emulator (either connected or remotely accessible via telnet, SSH, http, SSL, etc.), pen, voice input device, touch input device, remote control, etc. Output device(s) 1416 such as a display, a terminal or terminal emulator (either connected or remotely accessible via telnet, SSH, http, SSL, etc.), speakers, light emitting diodes (LEDs), etc. may also be included. All these devices are well known in the art and are not discussed at length.

In one embodiment, computer readable storage medium 1404 includes a primary and/or redundant POE source selector 1422 and monitoring/control module 1426 operable to maintain uninterrupted power according to flow diagrams 1000C-D, for instance.

It is appreciated that implementations according to embodiments of the present invention that are described with respect to a computer system are merely exemplary and not intended to limit the scope of the present invention. For example, embodiments of the present invention may be implemented on devices such as switches and routers, which may contain application specific integrated circuits (ASICs), field programmable gate arrays (FPGAs), etc. It is appreciated that these devices may include a computer readable medium for storing instructions for implementing a method according to flow diagram 500.

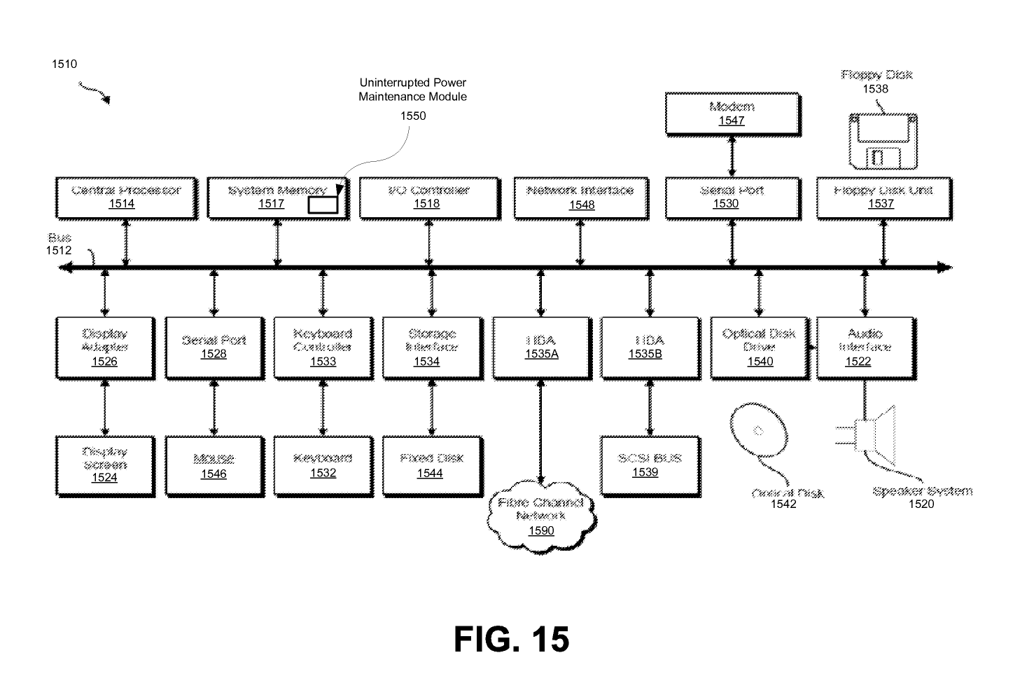

Referring now to FIG. 15, a block diagram of another exemplary computer system in accordance with one embodiment of the present invention is shown. FIG. 15 depicts a block diagram of a computer system 1510 suitable for implementing the present disclosure. Computer system 1510 includes a bus 1512 which interconnects major subsystems of computer system 1510, such as a central processor 1514, a system memory 1517 (typically RAM, but which may also include ROM, flash RAM, or the like), an input/output controller 1518, an external audio device, such as a speaker system 1520 via an audio output interface 1522, an external device, such as a display screen 1524 via display adapter 1526, serial ports 1528 and 1530, a keyboard 1532 (interfaced with a keyboard controller 1533), a storage interface 1534, a floppy disk drive 1537 operative to receive a floppy disk 1538, a host bus adapter (HBA) interface card 1535A operative to connect with a Fibre Channel network 1590, a host bus adapter (HBA) interface card 1535B operative to connect to a SCSI bus 1539, and an optical disk drive 1540 operative to receive an optical disk 1542. Also included are a mouse 1546 (or other point-and-click device, coupled to bus 1512 via serial port 1528), a modem 1547 (coupled to bus 1512 via serial port 1530), and a network interface 1548 (coupled directly to bus 1512). It is appreciated that the network interface 1548 may include one or more Ethernet ports, wireless local area network (WLAN) interfaces, etc., but are not limited thereto. System memory 1517 includes an uninterrupted power maintenance module 1550 which is operable to select a primary and/or redundant POE source and further operable to monitor whether the supply power is conforming to a given standard and maintain power to the sink device by switching between the primary and the redundant POE source when the supply power is non-conforming. According to one embodiment, the uninterrupted power maintenance module 1550 may include other modules for carrying out various tasks. For example, uninterrupted power maintenance module 1550 may include the primary and/or redundant POE source selector 1422 module and the monitoring/control module 1426, as discussed with respect to FIG. 14 above. It is appreciated that the uninterrupted power maintenance module 1550 may be located anywhere in the system and is not limited to the system memory 1517. As such, residing of the uninterrupted power maintenance module 1550 within the system memory 1517 is merely exemplary and not intended to limit the scope of the present invention. For example, parts of the uninterrupted power maintenance module 1550 may reside within the central processor 1514 and/or the network interface 1548 but are not limited thereto.

Bus 1512 allows data communication between central processor 1514 and system memory 1517, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 1510 are generally stored on and accessed via a computer readable medium, such as a hard disk drive (e.g., fixed disk 1544), an optical drive (e.g., optical drive 1540), a floppy disk unit 1537, or other storage medium. Additionally, applications can be in the form of electronic signals modulated in accordance with the application and data communication technology when accessed via network modem 1547 or interface 1548.

Storage interface 1534, as with the other storage interfaces of computer system 1510, can connect to a standard computer readable medium for storage and/or retrieval of information, such as a fixed disk drive 1544. Fixed disk drive 1544 may be a part of computer system 1510 or may be separate and accessed through other interface systems. Network interface 1548 may provide multiple connections to other devices. Furthermore, modem 1547 may provide a direct connection to a remote server via a telephone link or to the Internet via an internet service provider (ISP). Network interface 1548 may provide one or more connection to a data network, which may include any number of networked devices. It is appreciated that the connections via the network interface 1548 may be via a direct connection to a remote server via a direct network link to the Internet via a POP (point of presence). Network interface 1548 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 15 need not be present to practice the present disclosure. The devices and subsystems can be interconnected in different ways from that shown in FIG. 15. The operation of a computer system such as that shown in FIG. 15 is readily known in the art and is not discussed in detail in this application. Code to implement the present disclosure can be stored in computer-readable storage media such as one or more of system memory 1517, fixed disk 1544, optical disk 1542, or floppy disk 1538. The operating system provided on computer system 1510 may be MS-DOS®, MS-WINDOWS®, OS/2®, UNIX®, Linux®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. A device comprising:
a first power over Ethernet (POE) port; and
a second POE port, wherein one of the first POE port and the second POE port is configured as a primary port to supply power and another one of the first POE port and the second POE is configured as a redundant port to supply power,
wherein supply of power through the primary POE port is disabled and supply of power through the redundant POE port is enabled responsive to the supply of power through the primary POE port being non-conformant with a given standard.

2. The device as described by claim 1, wherein the first and the second POE ports are output ports on at least one source device configured to supply power to a sink device.

3. The device as described by claim 1, wherein the first POE port and the second POE port are input ports on a sink device.

4. The device as described by claim 1 further comprising:
a monitoring circuit configured to monitor supply of power through the primary POE port and further configured to determine whether supply of power through the primary POE port is conformant to the given standard; and
a control circuit configured to enable supply of power on the redundant POE port and disable supply of power on the primary POE port responsive to the monitoring circuit determining that the primary POE port is non-conformant to the given standard.

5. The device as described by claim 4, wherein the monitoring circuit is further configured to monitor supply of power through the redundant POE port and determine whether supply of power through the redundant POE port is conformant to the given standard, and wherein the control circuit is further configured to enable supply of power on the primary POE port and disable supply of power on the redundant POE port responsive to the monitoring circuit determining that the redundant POE port is non-conformant to the given standard.

6. The device as described by claim 4, wherein the control circuit is configured to cause an alert signal to be triggered in response to determining that a POE port is non-conformant with the given standard.

7. The device as described by claim 1 further comprising:
a switch configured to switch supply of power from the primary POE port to the redundant POE port responsive to a determination that the supply of power through the primary POE port is non-conformant with the given standard.

8. The device as described by claim 1, wherein data transmission capability associated with the redundant POE port remains enabled independent from whether supply of power through the redundant POE is enabled or disabled.

9. The device as described by claim 1, wherein the non-conformant with the given standard comprises a power failure.

10. A device comprising:
a monitoring circuit configure to monitor supply of power through a first power over Ethernet (POE) line from a first source device and determine whether the supply of power through the first POE line is conformant with a given standard; and
a control circuit configured to receive supply of power through the first POE line from the first source device and further configured to receive supply of power through a second POE line from a second source device, wherein the control circuit is configured to disable supply of power to a sink device through the first POE line and enable supply of power to the sink device through the second POE line in response to determining that the first POE line is non-conformant with the given standard.

11. The device as described by claim 10, wherein the first source device and the second source device are POE ports on a same device.

12. The device as described by claim 10, wherein the first source device is independent and separate from the second source device.

13. The device as described by claim 10, wherein the monitoring circuit and the control circuit are components within the sink device.

14. The device as described by claim 10, wherein data transmission capability associated with the first POE line and the second POE line remain enabled independent from whether supply of power through the first or the second POE lines is enabled or disabled.

15. The device as described by claim 10, wherein the monitoring circuit is further configured to monitor supply of power through the second POE line from the second source device and determine whether the supply of power through the second POE line is conformant with the given standard.

16. The device as described by claim 10, wherein the control circuit disabling supply of power to the sink device through the first POE line and enabling supply of power to the sink device through the second POE line is further in response to determining that the second POE line is conformant with the given standard.

17. The device as described by claim 10, wherein the non-conformant with the given standard comprises a power failure.

18. The device as described by claim 10, wherein the control circuit is configured to cause an alert signal to be triggered in response to determining that a POE line is non-conformant with the given standard.

19. A method comprising:
monitoring power supply on a first power over Ethernet (POE) line;
determining whether power supply on the first POE line is conformant with a given standard; and
responsive to determining that power supply on the first POE line is non-conformant with the given standard, enabling power supply on a second POE line, wherein the first and the second POE lines are configured to supply power from one or more source devices to a sink device.

20. The method as described by claim 19 further comprising:
monitoring power supply on the second POE line, wherein enabling power supply on the second POE line is responsive to power supply on the second POE line being conformant with the given standard.

21. The method as described by claim 19, wherein the non-conformant with the given standard comprises a power failure.

22. The method as described by claim 19 further comprising:
triggering an alert signal in response to determining that a POE line is non-conformant with the given standard.
